(19) United States
(12) Patent Application Publication
(10) Pub. No.: US 2013/0218803 A1
(43) Pub. Date: Aug. 22, 2013

(54) Consolidated Ranked Lists Based on Lists of Individual Contributors

(71) Applicant: CoolHotNot Corporation, (US)

(72) Inventors: David Brian Whittle, Springville, UT (US); Kevin Lee Banks, Round Rock, TX (US)

(73) Assignee: CoolHotNot Corporation, Springville, UT (US)

(21) Appl. No.: 13/769,319

(22) Filed: Feb. 16, 2013

Related U.S. Application Data
(60) Provisional application No. 61/600,636, filed on Feb. 18, 2012.

(51) Int. Cl. G06Q 30/02

(52) U.S. Cl. CPC G06Q 30/0282
USPC 705/347

(57) ABSTRACT

Methods, systems, and computer program products for generating one or more consolidated ranked lists of products or product groups based on inclusion of products on lists generated by individual contributors. One method includes steps of obtaining a plurality of individual lists, each individual list corresponding to one of a plurality of contributors, each individual list providing ratings or rankings of products by the corresponding contributor; and generating a consolidated list that provides rankings for the products or product groups listed on the individual lists based on the ratings or rankings of the products provided by each contributor. The consolidated rankings can be based, among other things, on a credibility score corresponding to each contributor, a product aging factor of each list item, the inclusion of a product on lists corresponding to different list types, and/or various named groupings of individual lists.

### CROSS REFERENCE TO RELATED APPLICATIONS

This application claims priority to U.S. Provisional Patent Application No. 61/600,636 filed on Feb. 18, 2012, the contents of which are hereby incorporated by reference.

### BACKGROUND OF THE INVENTION

1. The Field of the Invention

The present invention relates to methods, systems, and computer program products for ranking consumer products. More specifically, the present invention relates to generating consolidated ranked lists of products based on inclusion of the products on individual lists generated by individual contributors.

2. The Relevant Technology

Significant and growing numbers of people use the Internet to research products before making purchases. Growing numbers of web sites attempt to serve these users through a variety of means, including detailed product information and descriptions, feature lists, specifications, product reviews, and averaged user ratings of products, typically in the form of one to five stars based on the experiences of the users.

What is missing, however, is a simple means of capturing and ranking categorical user experience in an easy-to-understand manner that also reflects the credibility, authority, and/or trustworthiness of the user that is rating their product experience. Thus, current rating systems give as much weight to the ratings of unrepresentative competitors, shills, and other raters whose opinions represent a conflict of interest or are at best suspect, as they do to independent product category experts and others whose ratings are more likely to reflect the true nature of the product experience enjoyed by most people.

Similarly, even as users are generally becoming more willing to share product experiences with one another, the users are generally limited in scope to sharing product reviews and product ratings. Product reviews are limited in that they are often lengthy and/or irrelevant, while n-star product ratings reflect only a one-dimensional assessment of a multi-dimensional product experience. This assessment, when averaged with other one-dimensional assessments can be so ambiguous as to be misleading to decision makers.

Finally, a problem exhibited by many existing rating sites and systems is that new product models appear on the market with a frequency that leaves most newer products unrated or thinly rated on most sites, even though there may only be minor changes to a previous popular model which the newer model replaces.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope. In the drawings, like numerals designate like elements. Furthermore, multiple instances of an element may each include separate letters appended to the element number. For example two instances of a particular element “20” may be labeled as “20a” and “20b”. In that case, the element label may be used without an appended letter (e.g., “20”) to generally refer to every instance of the element; while the element label will include an appended letter (e.g., “20a”) to refer to a specific instance of the element.

FIG. 1 is a block diagram of a system incorporating features of the present invention;

FIG. 2 is a block diagram showing a flow of data according to one embodiment;

FIG. 3 illustrates a method of adding products to a contributor's lists according to one embodiment;

FIG. 4 illustrates a method of generating a comprehensive consolidated list of products or product groups according to one embodiment;

FIG. 5 illustrates a method of determining a score for each list item according to one embodiment;

FIG. 6 illustrates a method of determining an overall score for each product or product group according to one embodiment;

FIG. 7 illustrates a method of adjusting the overall scores for products/product groups found in multiple list types according to one embodiment; and

FIGS. 8A-8J depict various embodiments of icons that can be used to convey information to a user concerning the ranking and contributors for a specific product.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein. It will also be understood that any reference to a first, second, etc. element in the claims or in the detailed description is not meant to imply numerical sequence, but is meant to distinguish one element from another unless explicitly noted otherwise.

In addition, as used in the specification and appended claims, directional terms, such as “top,” “bottom,” “up,” “down,” “upper,” “lower,” “proximal,” “distal,” “horizontal,” “vertical,” and the like are used herein solely to indicate relative directions and are not otherwise intended to limit the scope of the invention or claims.

The present application relates to methods, systems, and computer program products for ranking consumer products. In particular, embodiments of the present invention provide innovative methods for generating consolidated ranked lists of products based on inclusion of the products on lists generated by individual contributors. The lists generated by the individual contributors can include products that are rated and/or ranked by the contributors or simply included on the lists.

Embodiments of the present invention mitigate or solve many of the problems endemic in existing approaches. For example, in some embodiments the products from the individual lists are grouped into product groups and the product groups are ranked in the consolidated lists. Among other benefits, this allows the product experiences of substantially similar products to be combined, thereby mitigating the problem of thinly rated products.

In some embodiments credibility scores corresponding to the contributors are used in determining the rankings of the products and product groups in the consolidated lists. Among other benefits, this allows the credibility, authority, relevance and/or trustworthiness of the contributors to be taken into account thereby increasing the reliability of product rankings and recommendations.

In some embodiments, a product aging factor is used in determining the rankings of the products and product groups in the consolidated lists. Among other benefits, this allows the newness of the products and product groups to be taken into account and/or the newness of the ratings of the products by the contributors to be taken into account. This can increase the relevance of product recommendations by boosting the product ranking for newer products more likely to be readily available for purchase.

In some embodiments, selection criteria are used to determine the contributors whose individual lists will be used to generate the consolidated lists. Among other benefits, this allows the ranked list to reflect the opinions of a targeted group, such as peers or friends, selected by a user of the system.

In some embodiments, multiple types of individual lists are generated and maintained by each contributor. For example, different list types can be directed to opposite experiences with products (e.g., good experiences vs. bad experiences). Among other benefits, this allows a multi-dimensional product experience to be reflected by the contributors that is easily understood by consumers.

Of course the benefits listed above are not exclusive and other benefits can be enjoyed by various embodiments of the present application.

Some embodiments employ a novel approach of gathering product lists that can be created and maintained by contributors and consolidating those individual lists into a combined list of ranked products or product groups. The gathered lists can correspond to different list types representing different types of experiences the contributors have had with the products. By way of example and not limitation, the list types can represent good experiences, bad experiences, and no experiences. The list types can also correspond to desired experiences, such as a wish list type corresponding to a desire to try or acquire a product.

The rating given to each product in a list by a contributor can be based on an adherence of the product to a nominal characteristic embodied by the list type corresponding to the list. That is, the relative ranking of each product on a list can reflect the strength of the product's adherence to the nominal characteristic of the list type. For example, if the list corresponds to a loved list type (e.g., the list may be entitled a “Loved List”), the ratings given each product in the list correspond to how much the contributor “loves” the product. Similarly, ratings given to each product in a list corresponding to a letdown list type (e.g., the list may be entitled a “Letdown List”), correspond to how much the contributor was “let down” by the product, and so forth. In one embodiment, an objective ranking for each product can be obtained based on the title or name of the list. For example, if the name of the list is “#1 Most Recommended” or “Top Ten Most Wanted,” the products in the list will be ranked according to those titles.

As a result, the relative ranking of each product in a consolidated list can reflect the combined wisdom of the contributors based on the ratings and list types on which the product is found. For example, the relative ranking can be dependent on the type and number of individual lists on which the product is listed, the position of the product listing within each individual list, the rating given to the product by each individual contributor, and the credibility of the contributor of each list, among other factors. In one embodiment, an algorithm is used that considers a variety of important factors to transform the contributor and product inputs into product scores by list which can determine the quality of the rankings.

In one embodiment, the products can be ranked in the consolidated list according to the strength of the product's relative adherence to the nominal purpose embodied by the list type corresponding to the consolidated list. This can be done, e.g., based on the ratings of each product in the individual lists of the ranking contributors. In some embodiments, the product rankings can take into account products listed on lists corresponding to opposing list types. For example, a product that is highly rated on a contributor's “Loved List” will contribute to a higher ranking on a consolidated “Loved List,” while a product that is highly rated on a “Letdown List” will contribute to a lower ranking on the consolidated “Loved List.”

Embodiments of the present invention can provide useful information about actual product experience of contributing individuals and/or groups to potential buyers of the product. For example, as discussed above, an objective ranking for each product can be obtained in some embodiments based on the title or name of the list. Also as discussed above, a credibility score can be assigned to each contributor to determine the quality and relevance of the contributor's ranking of products on their lists. In one embodiment, a product of only marginal interest can be excluded from the consolidated list if the product has not been listed on a predetermined number of contributors' lists, or if the product is listed on a predetermined number of lists of contributors of a threshold level of objectively measured credibility. This can help to narrow the field of products a potential buyer may want to consider.

In some embodiments, a ranking can be determined based on only a subset of the individual lists and/or contributors involved. By way of example and not limitation, the user can view product rankings based on one or more of the following: one or more selected categories, one or more selected keywords, one or more selected list types, a selected credibility level of the contributors, and one or more selected groups of individual list contributors, such as selected trusted advisors, friends, peers, industry experts, or the universe of all list contributors. Other limiting subsets are also possible. In one embodiment, a user can view product rankings based solely on one or more contributors selected by the user.

Thus, using embodiments of the invention, a user can view or combine lists of user-selected “experts” by category or keyword to identify, for example, most recommended or best products in a given category according to a group of trusted individual contributors. Similarly, a user can browse a wish list, for example, corresponding to a specific individual or a group of individuals to identify gift ideas; or browse a letdown list, for example, corresponding to a group of technical industry experts to identify products to avoid when shopping for consumer electronics.

In some embodiments, the products can be grouped into product groups and the consolidated list can rank the product groups instead of the specific products. Each product group can represent one or more of the products listed on the individual lists. In one embodiment, each product is represented by only one product group. In one embodiment, at least one of the product groups represents a plurality of different products and product models that have substantial similarities to each other. In one embodiment, each product group has a unique product group identifier, such that products having identical product group identifiers correspond to the same product group.

For example, if one of the products listed on one of the individual lists is a “Lenovo ThinkPad Edge 420” and another one of the listed products is a “Lenovo ThinkPad Edge 420s,” then both of those products could be grouped, for the purpose of rating or ranking or simplifying presentation to users, into a group entitled “Lenovo ThinkPad Edge 420 Series” if it is determined that both of the products are substantially similar to each other. The product group identifier corresponding to the group could be “Lenovo ThinkPad Edge 420 Series,” if desired.

In one embodiment, the group can be ranked in the consolidated list according to the strength of the product group's relative adherence to the nominal purpose embodied by the list type corresponding to the consolidated list. This can be done, e.g., based on the ratings of each product of the product group in the individual lists of the contributors and can take into account products listed on lists corresponding to opposing list types.

In some embodiments, the ranked comprehensive lists can be filtered and/or queried by product category, keyword, class and/or category of contributor, etc., e.g., to identify products exhibiting the strongest nominal attribute embodied by a desired type of list (e.g., “Best Loved,” “Most Wanted,” and “Biggest Letdown”) for a variety of groupings of individuals according to a user's choice of product category and/or keyword. By way of example, and not limitation, a consolidated ranked “Loved List” for industry experts could be filtered by category name “Mobile Phones” and keyword “Samsung” to identify the best cell phones made by Samsung according to industry experts.

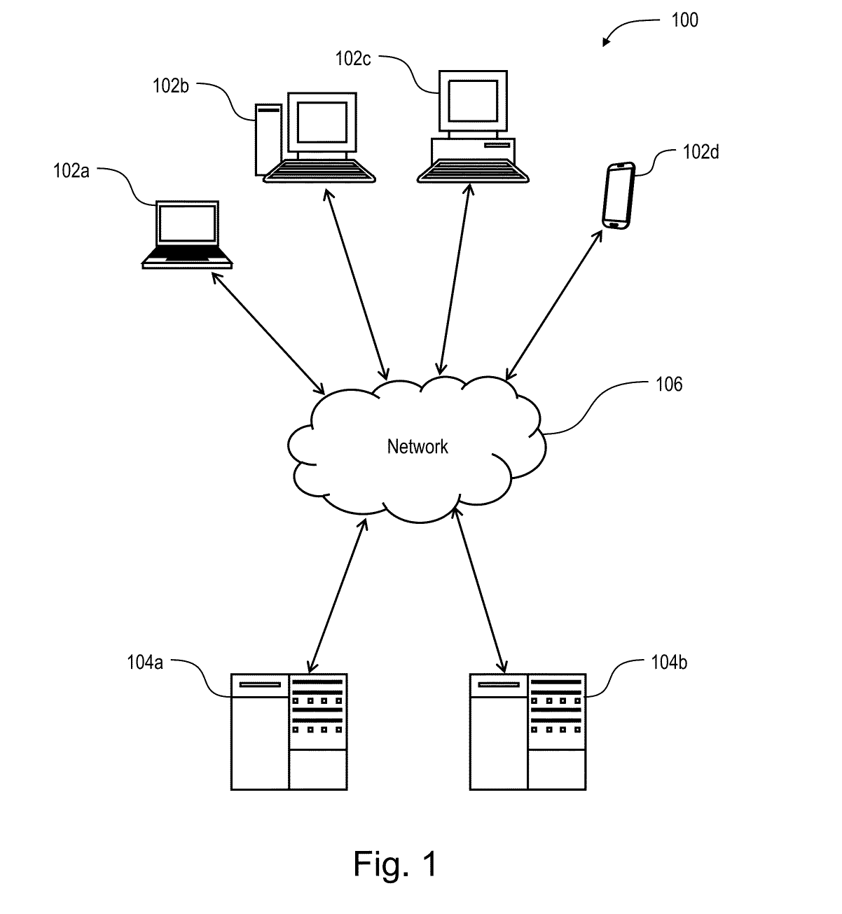

FIG. 1 depicts an example of a system 100 that can incorporate elements of the present invention. System 100 is exemplary only and does not show every element envisioned in every system. One skilled in the art will appreciate that system 100 can be modified and optimized based on the individual needs of the particular users. System 100 can include one or more client machines 102a-d (generally referred to herein as client machine(s) 102 or client(s) 102) in communication with one or more server machines 104a-b (generally referred to herein as server machine(s) 104 or server(s) 104) over a network 106. The client machine(s) 102 can, in some embodiments, be referred to as a single client machine 102 or a single group of client machines 102, while the server machine(s) 104 may be referred to as a single server 104 or a single group of servers 104. Although four client machines 102 and two server machines 104 are depicted in FIG. 1, any number of clients 102 may be in communication with any number of servers 104. In addition, although a single network 106 is shown connecting client machines 102 to server machines 104, it should be understood that multiple, separate networks may connect a subset of client machines 102 to a subset of server machines 104.

Embodiments of the present invention, including client machines 102 and server machines 104, may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two different types of computer-readable media: computer storage media and transmission media.

Computer storage media includes RAM, ROM, EEPROM, CD-ROM, solid state drives (“SSDs”) (e.g., based on RAM), flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired and wireless) to a computer, the computer properly views the connection as a transmission medium. Transmission media can include network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface controller (NIC)), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

By way of example, and not limitation, common network environments 106 that can be used with the present invention include Local Area Networks (“LANs”), Wide Area Networks (“WANs”), and the Internet. Accordingly, each of the computer systems as well as any other connected computer systems and their components, can create message related data and exchange message related data as needed (e.g., Internet Protocol (“IP”) datagrams and other higher layer protocols that utilize IP datagrams, such as, Transmission Control Protocol (“TCP”), Hypertext Transfer Protocol (“HTTP”), User Datagram Protocol (“UDP”), etc.) over the network 106.

Those skilled in the art will appreciate that the invention may be practiced in network computing environments with many types of computer system configurations. By way of example and not limitation, client machines 102 and server machines 104 can include: personal computers, desktop computers, laptop computers, message processors, hand-held devices, multi-processor systems, microprocessor-based or programmable consumer electronics, network PCs, minicomputers, mainframe computers, portable tablet devices, mobile telephones, PDAs, video game consoles, portable media players, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. Program modules for one entity can be located and/or run in another entity's data center or “in the cloud.”

An operating environment for the devices of system 100 may comprise or utilize a processing system having one or more microprocessors and system memory. In accordance with the practices of persons skilled in the art of computer programming, embodiments of the present invention are described below with reference to acts and symbolic representations of operations or instructions that are performed by the processing system, unless indicated otherwise. Such acts and operations or instructions are referred to as being “computer-executed,” “CPU-executed,” or “processor-executed.”

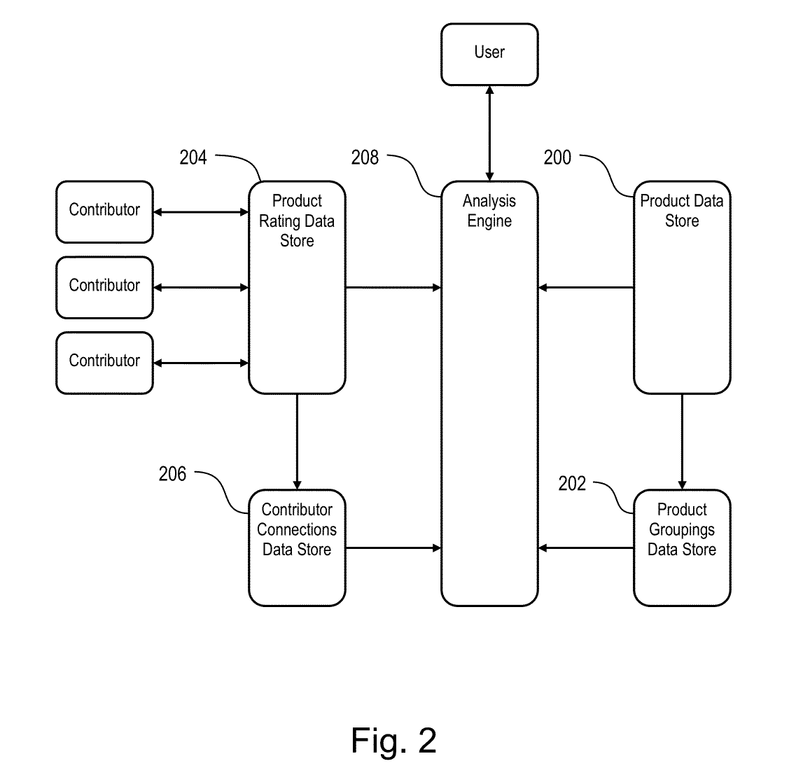

FIG. 2 depicts a data flow diagram of system 100 according to one embodiment. As shown in FIG. 2, system 100 can comprise a number of product-related data stores. For example, the depicted embodiment can include a product data store 200, a product groupings data store 202, a product rating data store 204, and a contributor connections data store 206. Other product-related data stores are also possible. The data stores enable the storage and recall of information about contributors and products.

Each data store can be used to store and maintain various types of data. As such, the data stores can be databases or other types of data stores, as are known in the art. For example, each data store can be a separate database or a separate table in a single database. Alternatively, one or more of the data stores can incorporate multiple databases or multiple tables in one or more databases. Other arrangements are also possible. The data stores can be incorporated into a single server machine or can be distributed over more than one server machine.

Product data store 200 can contain information about each product and can be used to enable tracking of products and characteristics, including, e.g., the age and relative currency of the product. By way of example and not limitation, product data store 200 can contain one or more of the following information about each product:
the manufacturer of the product,
the model number of the product,
the product brand,
the date the product was announced,
the date the product was generally available to the public,
a unique product identifier, and
a product group identifier.

The unique product identifier can represent the exact and distinct model of a given product (e.g., “Apple iPad 2”) and is also referred to herein as a “longname.” The product group identifier can represent the group to which the product belongs (e.g., “Apple iPad”) and is also referred to herein as a “shortname.”

Product groupings data store 202 can contain information about the product groups. In some embodiments, each product group is intended to only include products with essentially similar characteristics such that the user experience is likely to be similar, according to the judgment of an informed or trained person, or algorithmically based on an identical manufacturer and brand, and exhibiting similar user experience characteristics.

Product rating data store 204 can contain information about the individual lists of each contributor and the corresponding product ratings and can be used to enable tracking of contributors and their lists. By way of example and not limitation, product rating data store 204 can contain one or more of the following information for each item in a contributor's list:
the name of the list in which the product is found,
the position of the product (rank) within the list in which the product is found,
the longname of the product,
the shortname of the product,
the rating given to the product by the contributor, and
comments from the contributor regarding the product.

Manners in which the ratings can be determined are discussed in detail below. Comments from the contributor can include reasons why the contributor is including the product on the designated list, such as the reasons for recommending the product, or wanting the product, or being disappointed by the product. Other comments can also be set forth.

Contributor connections data store 206 can contain information regarding the connections between contributors. This can allow an objective assessment of credibility of the individual contributors. For example, credibility can be based on the popularity and trust each contributor has obtained, based on the number of other contributors that are connected to that contributor. By way of example and not limitation, contributor connections data store 206 can contain one or more of the following information corresponding to each contributor:
the username for the contributor,
the date the contributor became a contributor,
the date of each login to the system by the contributor,
the email address of the contributor,
the number of “followers” the contributor has in the system,
the number of “friends” the contributor has in the system, and
the number of referrals the contributor has made who have become contributors.

In one embodiment, a “follower” of a particular contributor is a user who unilaterally decides to keep track, or follow, the rankings of the particular contributor and/or has designated that particular contributor as one whose opinion is trustworthy. In one embodiment, list contributors who have mutually agreed that they are friends are provided the opportunity to also “follow” that friend as someone whose opinion is trusted. In one embodiment, contributors are considered “friends” if both contributors have mutually agreed to follow each other's rankings.

Remaining with FIG. 2, an analysis engine 208 can use the data stored in the various data stores to generate an overall ranking for each product in a list. Analysis engine 208 can be incorporated into one or more special purpose or general-purpose computers, such as those discussed above, and can be located at one or more server machines 104, one or more client machines 102, or a combination of the two types. Alternatively, analysis engine 208 can be “in the cloud”, as discussed above. Other configurations are also possible.

A subjective product experience can be captured and stored when a contributing individual generates or adds products to one or more personal lists of products. Each of these personal lists can correspond to a type of list and can reflect one aspect of the real-life, subjective experiences of the individual contributors corresponding to the corresponding list type. Different lists can be directed toward “good” experiences and “bad” experiences. For example, a contributor can maintain a “Loved List” containing a list of products the contributor uses, prefers, and recommends and a “Letdown List” containing a list of products the contributor has used but does not like. Of course, other types of lists can also be maintained. For example, the contributor can also maintain a “Wanted List” containing a list of products the contributor has not used but desires to use.

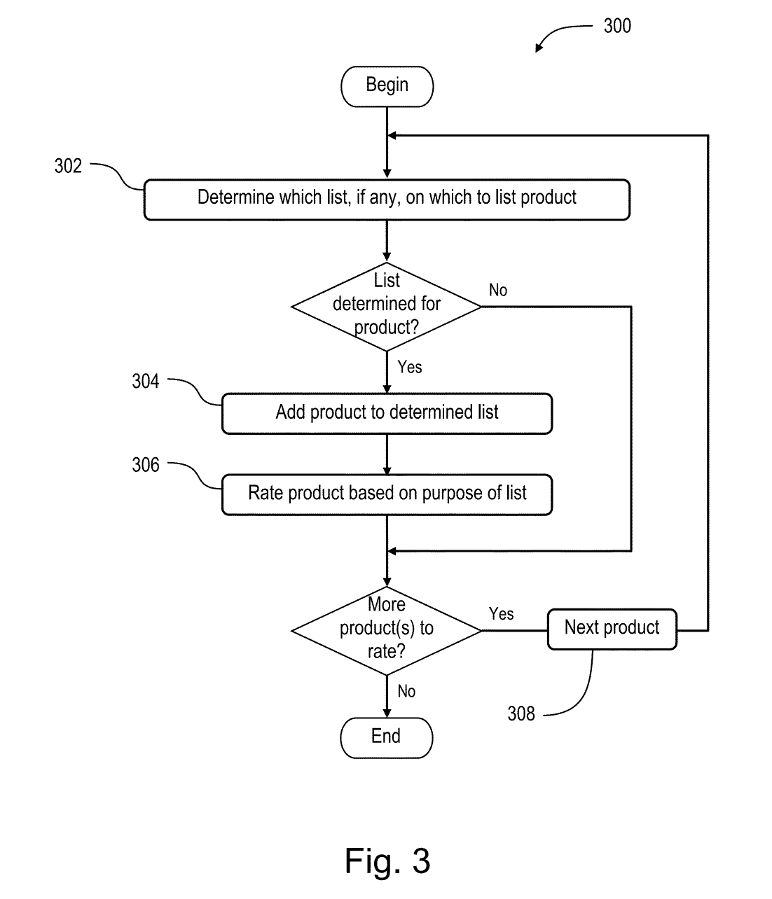

FIG. 3 illustrates a method 300 of adding products to a contributor's lists, according to one embodiment. Steps of the method can be performed by the contributor at a client machine 102 and/or at a server machine 104. In one embodiment, method 300 comprises one or more computer applications. In one embodiment, method 300 is performed using the internet.

In step 302, the contributor views a product and determines which list, if any, on which to list the particular product. In one embodiment, the contributor can view and select from products already on one or more consolidated ranked lists or on one or more individual lists. In one embodiment, the contributor selects the product from a general list of products supplied by the system. This general list of products can be generated by the system to include all or a subset of the products whose information is stored in the product data store 200 shown in FIG. 2. In one embodiment, the general list of products may include products that match a keyword search of the site's existing product database and/or various data feeds from vendors, affiliate brokers, or other data providers. The list of products can be a simple word list and/or can include graphics showing what the product looks like. Other manners of displaying the product to the contributor can also be used. In one embodiment, the contributor can add information corresponding to a product to the product data store if the product information is not already stored therein.

In one embodiment, to determine the appropriate list for the product, the contributor can reflect on his or her experience (or lack thereof) with the product and determine, based on the name of the list, which list is most appropriate for the product. That is, the determined list can be the list that best matches the contributor's overall perception of the product or the status of the product within the contributor's experience. The contributor can alternatively determine that the product does not belong on any of the lists. This can occur, e.g., if the contributor has not had any experience with the product or the contributor has had a mediocre experience with the product such that the product would not qualify for preferred or non-preferred status for the contributor or if the contributor sees no reason to even want to try the product.

If, in step 302, the contributor determines that the product should be listed on one of the lists, then steps 304 and 306 are performed. In step 304, the contributor adds the product to the determined list. In one embodiment, the contributor can simply “drag and drop” the product from the general list to the desired list. In one embodiment, the user can click on an appropriately labeled button or icon, e.g. a blue thumbs up icon to add a product to a “Loved List,” a red thumbs up icon to add a product to a “Wanted List,” or a yellow thumbs down icon to add a product to a “Letdown List.” Other manners of adding the product to a selected list can also be used. By way of example and not limitation, after the product has been added to one of the contributor's lists, the product can be automatically removed from the general list corresponding to the contributor, or an icon or other manner of differentiation can be automatically set forth indicating that the product is now in one of the contributor's lists. In one embodiment, if a contributor determines that a product that has been listed on the contributor's “Wanted List” should now be listed on the “Loved List” or the “Letdown List,” that product can be automatically removed from the “Wanted List.”

In step 306, the contributor can rate the product, if desired, based on the contributor's experience with the product or the contributor's overall perception of the product. For example, the rating can be based on a 5-point scale that reflects how strongly the contributor believes the product adheres to the nominal characteristic embodied by the particular list type. For example, a contributor may rate a product as a 5 on a “Loved List” to indicate that the contributor absolutely loves the product or a “1” to indicate that the contributor merely likes the product. Similarly, a contributor may rate a product as a 5 on a “Wanted List” to indicate that the contributor desires to use the product as much or more than other products on the list. A contributor may rate a product as a 5 on a “Letdown List” to indicate that the product was expensive and resulted in significant frustration when used by the contributor or a “1” to indicate that the product was not quite up to expectations. In some embodiments, the contributor can also add comments, e.g., a “mini-review,” relating to the product or to the contributor's use thereof. In some embodiments, the contributor may rank the products on the list to indicate degree of adherence to the nominal purpose of the list instead of rating products to accomplish that same purpose

If, in step 302, the contributor determines that the product should not be listed on any of the lists, then steps 304 and 306 are not performed for the particular product. After the product has been skipped, an icon or other manner of differentiation can be automatically set forth indicating that the product has been skipped by the contributor. This can allow the contributor to identify products that have been skipped and allow the contributor to review the products at a later time, if desired.

In step 308, if there are one or more products still to be rated, the contributor goes to the next product and repeats steps 302, 304, and 306 for the next product. In this manner, steps 302, 304, and 306 are repeated for each product. In some embodiments, the contributor can repeat steps 302, 304, and 306 for each product in the general list or for a subset of those products. Furthermore, if the contributor has no experience or opinion with respect to one or more of the products, the contributor can skip that product and not include that product in any of the lists, as discussed above. Of course, method 300 is just one way of adding products to a contributor's lists. Other methods can alternatively be used.

Method 300 can be used to generate new product lists or to maintain existing product lists. In some embodiments, the product lists are made available to other contributors, thereby allowing contributors to share their opinions and experiences of a product with each other based on the list type of the list in which the contributor places the product and the rating of the product within the list. In some embodiments, the product lists are made available to users to assist the users in making decisions regarding the listed products. In some embodiments, the user encounters products on other web sites and a browser plug-in or other piece of code enables the contributor to add a product being viewed by the user. In one embodiment, the users include one or more contributors.

For example, using the individual product lists, useful information can be provided to users who are potential buyers of a product reflecting actual product experience of contributing individuals and/or groups. For example, the individual lists can be used as inputs and processed against an existing database of product information and contributor information to generate a comprehensive consolidated list of products. If desired, an overall product score can be calculated based on one or more of the following: the type and number of individual lists on which the product is listed, the position of the product listing within each individual list, the rating given to the product by each individual contributor, and the credibility of the contributor of each list.

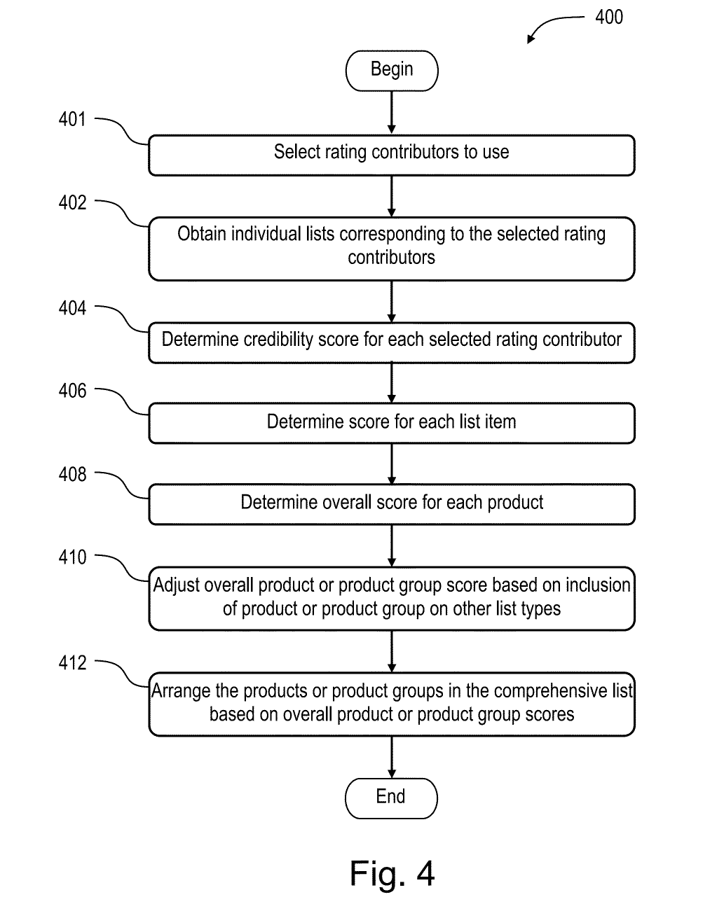

FIG. 4 illustrates a method 400 of generating a comprehensive consolidated list of products or product groups, taking into account individual lists of two or more selected contributors according to one embodiment. In on embodiment, a user can select whether products or product groups are desired. In one embodiment, product groups are maintained transparently for users, with specific products being maintained and displayed on individual lists and product groups being displayed on consolidated ranked lists. In one embodiment, the comprehensive consolidated list is generated for product groups unless the user indicates otherwise. The user can also select a desired list type to use for method 400 or method 400 can be performed for each list type. The selected contributors can include all of the contributors in the system or a subset thereof. In one embodiment, all of the contributors are considered to be selected unless the user indicates otherwise. In one embodiment, the user can select the contributors whose lists the user wants to combine. This flexibility can help the user decide which products or product groups are best and recommended, new and wanted, and/or worst and disappointing based on contributors whose opinions matter to the user.

Although the steps of method 400 are presented in a particular order, the steps can be performed in other orders as desired. Furthermore, one or more of the method steps can be omitted, if desired, to meet the needs of a particular application. Steps of the method can be performed at a client machine 102 and/or at a server machine 104. In one embodiment, method 400 comprises one or more computer applications. In one embodiment, method 400 is performed using the internet.

Method 400 is directed to a single consolidated list for the list type and group of contributors selected by the user. Method 400 can be performed multiple times to generate different comprehensive lists for different list types and/or for the same list type but using different contributors. In one embodiment, one or more of the steps of method 400 can be performed by analysis engine 208, using inputs from the various applicable data stores 200-206 shown in FIG. 2.

In step 401, the contributors that will be used are determined. This can be accomplished by receiving input from a user as to which contributors to use. The input can be in the form of a selection of individual contributors, or of one or more groups of contributors corresponding to one or more selection criteria. In one embodiment, all of the contributors are used unless the user indicates otherwise. In this embodiment, if the user does not make any selection, all of the contributors will be automatically selected.

In one embodiment, the user can select individual contributors. This can be accomplished, for example, by the user selecting one or more contributors from a list of all of the contributors. Alternatively, the user can enter one or more names or other keywords to find individual contributors corresponding to the entered name or keyword.

In one embodiment, the user can select a group of contributors corresponding to a particular selection criteria. By way of example and not limitation, one or more of the following selection criteria can be used:
contributors that are recognized experts in a particular industry,
contributors that are individually-selected experts,
contributors that are trusted advisors of the user
contributors that are designated friends of the user,
contributors that belong to a specific demographic group,
credibility level of the contributors, and
contributors that correspond to a specific keyword or category.

The particular industry can be determined by the user via selection from a list or via keyword entry. Any demographic information can be used to determine the demographic group. For example, the demographic group can be based on one or more of the following demographic factors:
age of the contributors,
gender of the contributors,
residence location of the contributors, and
income of the contributors.
   For example, a user can indicate that the contributors must be 40-50 years old, male, living in the state of Utah, and having an annual income between $30,000 and $40,000. Of course, other demographic factors, values, and ranges are also possible.

Once the selection is made by the user, the particular contributors corresponding to the selected criteria can be determined. Thus, using embodiments of the invention, a user can view or combine lists of user-selected “experts” by category or keyword to identify, for example, most recommended or best products in a given category. Similarly, a user can browse a wish list, for example, corresponding to a specific individual or a group of individuals to identify gift ideas; or browse a letdown list, for example, corresponding to a group of industry experts to identify products to avoid when shopping for consumer electronics

In step 402, the individual lists corresponding to the selected contributors are obtained. In one embodiment, the individual lists are stored in the product rating data store 204 shown in FIG. 2. In one embodiment, obtaining the individual lists comprises determining the location of the individual lists within the product data store. In one embodiment, obtaining the individual lists comprises receiving the individual lists from one or more client or user machine. Other manners of obtaining the individual lists are also possible.

In step 404, a credibility score is determined for each selected contributor. As noted above, this can include all of the contributors of the system or a subset thereof. The credibility score of the contributor can be designed to reflect a relative importance of the rankings of the contributor. In one embodiment, a raw credibility score can be generated for each contributor. By way of example and not limitation, the raw credibility score for each contributor can be based on one or more of the following factors:
a. the number of “followers” the contributor has in the system,
b. the number of referrals the contributor has made who have become contributors,
c. the number of “friends” the contributor has in the system,
d. the length of time the contributor has been a contributor (e.g., number of days)
e. the length of time since the last login and/or rating by the contributor, (e.g., a number of days)
f. the age of the contributor, and
g. a confirmation of personal information of the contributor, such as the mailing address and/or email address of the contributor.
   In one embodiment, factors d and e, above are combined as follows: the number of days the contributor has been a contributor less the elapsed number of days since the last login by the contributor.

Each of the above factors can be assigned a weighting factor based on the importance of the factor, as determined by the system or some other weighting entity. In one embodiment, the weighting factors can decrease, e.g., logarithmically, as one moves down the above list from a to g. In one embodiment, the value of one or more of the factors can be expressed as a percentile of the range of current values for the particular factor. The raw credibility score for the contributor could then be an aggregation of each of the factor values, weighted by the weighting factors corresponding to the factors.

For example, to determine a raw credibility score RCS for a contributor C using n factors, the following equation could be used:

$$R C {S}_{C} = {\sum }_{f = 1}^{n} {W}_{f} ( \frac{{V}_{f , C}}{{R}_{f}} ) , \qquad ( equation 1 )$$

where f is the factor number, V is the raw factor value corresponding to the factor f, W is the weighting factor corresponding to the factor f, and R is the range of values of the member population corresponding to the factor f, or the high value minus the low value corresponding to the factor f. In some embodiments, W can be a number designating the weight assigned for the designated factor. For factors that are simply true/false or confirmations, W can be a binary value (i.e., 0 or 1) indicating whether or not the factor is true or confirmed and V and R can be 1. In some embodiments, each individual factor input can be an integer value

In one embodiment, the raw credibility score of each contributor can be converted to a final credibility score to normalize the scores between contributors. For example, in one embodiment, final credibility scores can be obtained by distributing the raw credibility scores between 0 and 10. In one embodiment, the lowest 25% of the final credibility scores are distributed between 0 and 1, the lower middle 25% are distributed similarly between 1 and 3, the upper middle 25% between 3 and 6, and the upper 25% between 6 and 10, all proportionately to the corresponding raw scores. Equation 2 reflects one embodiment of determining the final credibility score FCS for a contributor C using the values above.

$$F C {S}_{C} = {basescore}_{Q} + {scorerange}_{Q} ( \frac{R C {Srank}_{C} - {baserank}_{Q}}{{members}_{Q}} ) , \qquad ( equation 2 )$$

where RCSrank is the rank of the raw credibility score corresponding to contributor C with respect to the raw credibility scores of the other contributors, Q is the quartile in which RCSrank is found with respect to all of the ranks of the contributors, basescore is the lowest value for contributor scores corresponding to the quartile Q, scorerange is the range of score values corresponding to the quartile Q, baserank is the lowest rank corresponding to the quartile Q, and members corresponds to the number of contributor scores within the quartile Q. For the embodiment discussed above, if the total number of contributors is 1000, the basescore, scorerange, baserank, and members values for the quartiles can be as follows. 1st (or highest) quartile: basescore₁=6, scorerange₁=4, baserank₁=7500, and members₁=2500; 2nd quartile: basescore₂=3, scorerange₂=3, baserank₂=5000, and members₂=2500; 3rd quartile: basescore₃=1, scorerange₃=2, baserank₃=2500, and members₃=2500; 4th (or lowest) quartile: basescore₄=0, scorerange₄=1, baserank₄=0, and members₄=2500.

In step 406, a score is determined for each item listed in each contributor's list corresponding to the selected list type. The list item score can be based on a number of factors, such as, e.g., the position of the product in the list, the rating given the product by the contributor, the credibility of the contributor, the age of the product, and so forth.

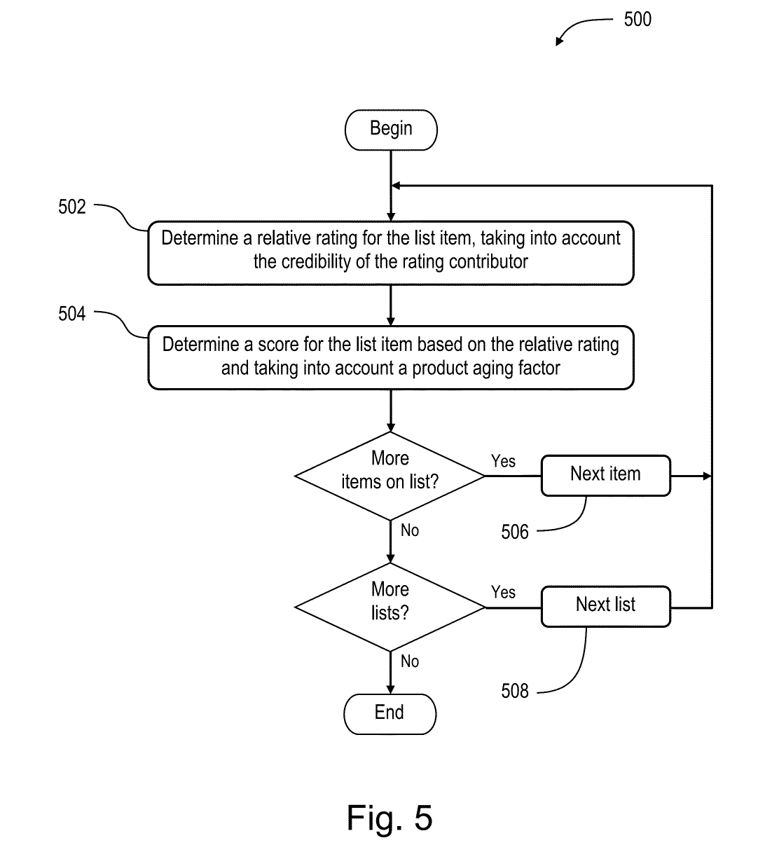

FIG. 5 illustrates one embodiment of a method 500 that can be used to determine the score for each list item. In step 502, a relative rating is determined for the list item. In one embodiment, the relative rating can be obtained by multiplying the rating given by the contributor of the product corresponding to the list item by the credibility score corresponding to the contributor. The credibility score used to multiply the product rating can be the raw or final credibility score, discussed above, or some other type of credibility score. Equation 3 reflects one embodiment of determining the relative rating rr of a list item li of a contributor C:

rr_{li,C}=rating_{li,C}*FCS_{C}, (equation 3)

where rating is the rating given to the list item li by the contributor C, and FCS is the final credibility store of the contributor C.

In step 504, the score for the list item is determined based on the relative rating, taking into account a product aging factor. The product aging factor of each list item can be based on the newness of the product and the newness of the rating of the product by the contributor corresponding to the list item. The product aging factor can be different for each product.

In one embodiment, the product aging factor can be determined using a two-step process. First, a raw product aging factor can be determined for the list item by taking into account the age of the product and the age of the rating. For example, the raw product aging factor can be based on a first length of time that has elapsed since the product corresponding to the list item has been generally made available to the public, and a second length of time that has elapsed since the product corresponding to the list item has been rated by the contributor associated with the list item. Equation 4 shows one manner of determining a raw product aging factor RPAF for a list item li corresponding to a contributor C.

RPAF_{li,C}=daysavailableₚ−lastupdate_{p,C}, (equation 4)

where daysavailable is the number of days that have elapsed since the product p corresponding to the list item li was generally made available to the public and lastupdate is the number of days that have elapsed since the product p was listed or updated by the contributor C.

Second, a final product aging factor can be determined by normalizing the raw product aging factor with respect to the raw product aging factors of the other list items. For example, in one embodiment, the final product aging factor can take into account the range of raw product aging factor values in the lists. For example, Equation 5 shows one manner of determining a final product aging factor FPAF for a list item ii corresponding to a contributor C.

$${FPAF}_{li , C} = 1 + ( \frac{{RPAF}_{li , C}}{RPAFrange} ) , \qquad ( equation 5 )$$

where RPAF is the raw product aging factor for the list item ii for the contributor C, and RPAFrange is the range of raw product aging factor values in the lists.

The score for the list item can be determined by multiplying the relative rating of the list item by the product aging factor:

score_{li,C}=rr_{li,C}*FPAF_{li,C}, (equation 6)

In step 506, if there are one or more list items on the list whose score has not yet been determined, steps 502 and 504 are repeated for the next item. Similarly, in step 508, if there are more lists that have not yet been analyzed, either corresponding to the same contributor or to the other selected contributors, steps 502 and 504 are repeated for the items in the next list. As a result, steps 502 and 504 can be repeated for each item on the selected contributor's lists corresponding to the selected list type and for each selected contributor associated with the particular comprehensive list.

Other manners of determining product aging factors and/or list item scores can also be used. In addition, although the steps of method 500 are described as separate steps, it will be appreciated that the steps can be combined into one step, or expanded into more steps, if desired. For example, the score for each list item can be determined by taking into account the product rating, the contributor credibility score, and the product aging factor in a single step.

Returning to FIG. 4, in step 408, an overall score is determined for each product or product group found in the contributor's lists corresponding to the selected list type. Whether the overall score is desired for products or for product groups is based on which type of comprehensive consolidated list is desired, and can be decided by the user before method 600 is performed, as discussed above. In one embodiment, the overall scores for product groups is the default unless the user indicates otherwise. To aid in the discussion below, the term “product/product group” and its derivatives will be used to signify that whether “product” or “product group” is intended depends on which has been selected by the user.

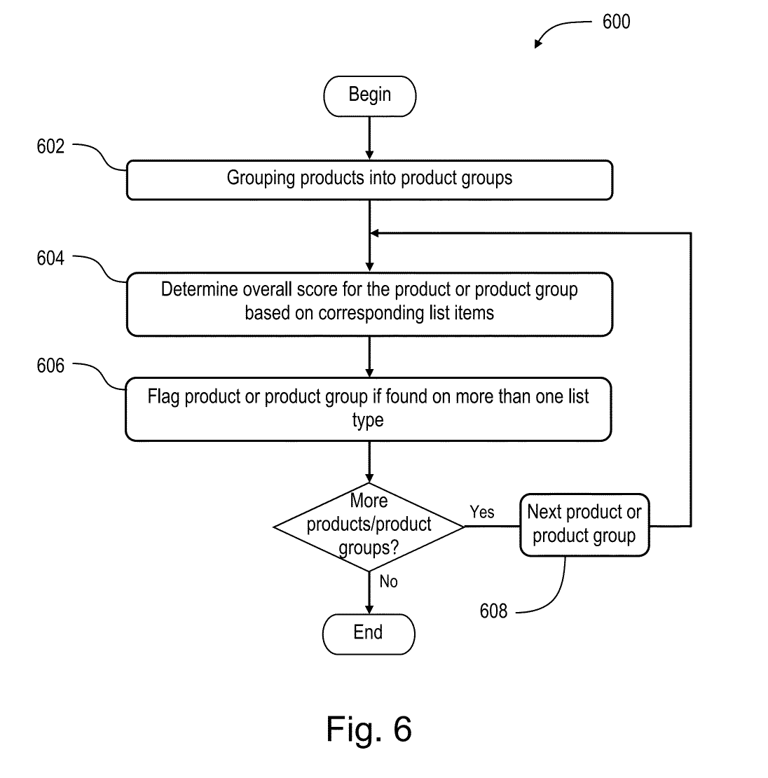

FIG. 6 illustrates one embodiment of a method 600 that can be used to determine the overall score for each product/product group. If the consolidated list is being generated for product groups, step 602 can be performed. In step 602, the products are grouped into product groups. Each product group can represent one or more of the products listed on the individual lists. In one embodiment, each product is represented by only one product group. In one embodiment, at least one of the product groups represents a plurality of different products that have substantial similarities to each other. In one embodiment, each product group has a unique shortname, such that products having identical shortnames correspond to the same product group. If the consolidated list is being generated for products instead of product groups, step 602 can be omitted.

In step 604, an overall score is determined for the product/product group. In one embodiment, this can be done by simply aggregating all of the list item scores corresponding to the product/product group.

In step 606, if the product/product group is found on more than one list type, a multiple list flag can be set corresponding to the product/product group. In one embodiment, a different overall score can also be determined for the product/product group for the other list type(s) using the steps discussed herein.

In step 608, if there are one or more products/product groups whose overall score has not been determined, steps 604-606 can be repeated for the next product/product group.

Other manners of determining an overall score for each product/product group can also be used. In addition, although the steps of method 600 are described as separate steps, it will be appreciated that any of the steps can be combined, or any of the steps can be expanded into more steps, if desired.

Returning to FIG. 4, in step 410, the overall scores are adjusted, if needed, based on the inclusion of products/product groups on lists corresponding to other list types. In one embodiment, only opposing list types are used, such as list types corresponding to “good” and “bad” experiences the contributors have had with the products/product groups or “desired” and “undesired” products/product groups. In one embodiment, the products/product groups associated with multiple list types can be determined using the multiple list flag discussed above. In one embodiment, the overall scores are adjusted based on a comparison of the ratings of the products of the particular product group on the individual lists. In this manner, the ranking of a product/product group in a consolidated list corresponding to a particular list type can be adjusted based on inclusion of the product/product group in other list types and adherence of the product/product group to the nominal characteristics embodied by the other list types.

In one embodiment, if a product/product group has overall scores corresponding to more than one list type, the overall scores of the product/product group can be consolidated into one overall score which takes into account the other overall scores of the product/product group to ensure that the product/product group is included in only one ranked list type.

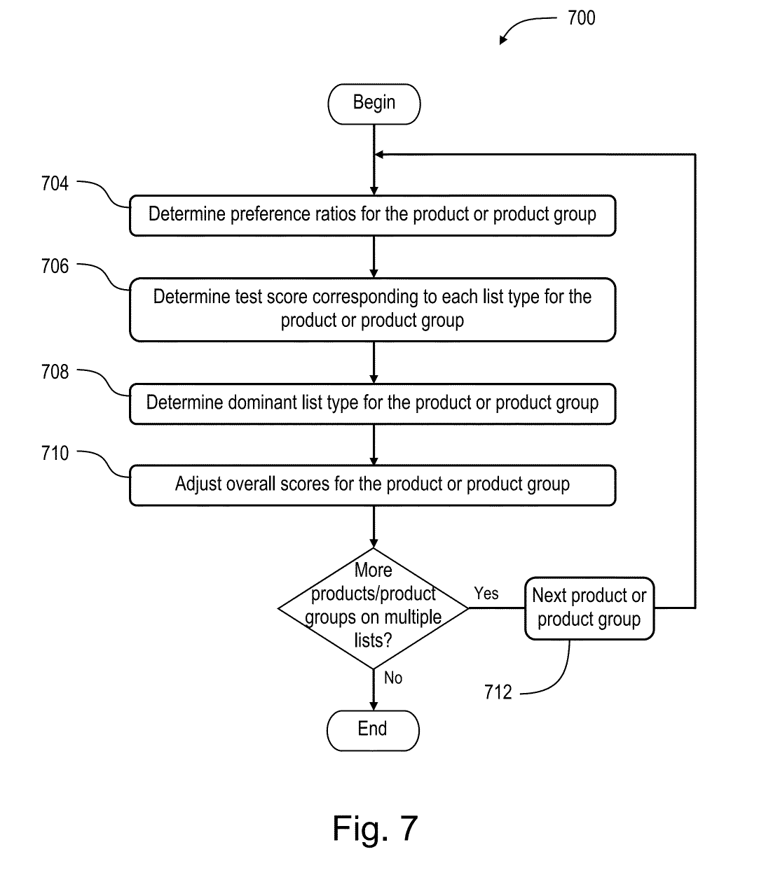

FIG. 7 illustrates one embodiment of a method 700 that can be used to adjust the overall scores for products/product groups found in multiple list types. In step 702, the list types on which a product/product group is found are compared to determine which list type has the highest overall score corresponding to the product/product group.

In step 704, a preference ratio is determined for the product/product group with respect to each list type the product/product group is found. To do so, the number of list item scores corresponding to the product/product group can be determined for each list type (e.g., Loved list type vs. Letdown list type). In one embodiment, the number of contributors that included the item—by product/product group—on each list type is determined. The numbers of list item scores corresponding to the opposing lists can be compared to determine the preference ratio PR of the particular list type LT, as shown in FIG. 7.

$${PR}_{LT} = \frac{{NoOfC}_{LT}}{{NoOfC}_{OLT}} , \qquad ( equation 7 )$$

where NoOfC is the number of contributors having the product/product group on their corresponding individual list type LT, and on the other list types OLT.

For example, if four contributors listed a product/product group on their respective “Loved Lists,” and seven other contributors listed the same product/product group on their respective “Letdown Lists,” the preference ratios, based on equation 7, would be four to seven, (i.e., 4:7 or 4/7 or 0.5714) with respect to the loved list type and seven to four (i.e., 7:4 or 7/4 or 1.75) with respect to the letdown list type.

In step 706, a test score corresponding to the product/product group is determined for each list type. The test score can be based on the preference ratio. In one embodiment, if the preference ratio of the list type corresponding to the product/product group is greater than or equal to 1, the test score can be equated to the product/product group score and if the preference ratio is less than one, the test score test can be equated to the product/product group score times the preference ratio, as shown in equation 8.

test_{LT}=scoreₚ, if PR_{LT}≧1; or, (equation 8a)

test_{LT}=PR_{LT,p}*scoreₚ, if PR_{LT}<1, (equation 8b)

where PR is the preference ratio corresponding to the list type LT and score corresponds to the overall score for the product/product group p.

In step 708, the test scores for each of the list types are compared and the list type having the highest test score is determined to be the dominant list type for the product/product group.

In step 710, the overall scores of the product/product group in the corresponding lists are adjusted. In one embodiment, the product/product group score for the consolidated list corresponding to the dominant list type is adjusted to equal the dominant list type test score minus the test scores corresponding to the other list types, as shown in equation 9. In one embodiment, the product/product group is removed from the consolidated lists corresponding to the other list types.

NewScore_{LT,p}=test_{LT,p}−test_{OLT,p}, (equation 9)

In step 712, if there are one or more products/product groups that are still on multiple list types, steps 704-710 are repeated for the next product/product group.

Other manners of adjusting the overall score or determining the preference ratio or the test scores corresponding to a product/product group can also be used. In addition, although the steps of method 700 are described as separate steps, it will be appreciated that any of the steps can be combined, or any of the steps can be expanded into more steps, if desired.

Returning to FIG. 4, in step 412, the products/product groups are arranged in the consolidated list based on the product group scores to indicate a relative ranking of the product/product group.

Other manners of generating a comprehensive consolidated list of products or product groups can also be used. In addition, although the steps of method 400 are described as separate steps, it will be appreciated that any of the steps can be combined, or any of the steps can be expanded into more steps, if desired. Furthermore, method 400 can be modified as needed and are also envisioned by the present application.

In one embodiment, if method 400 is performed multiple times to generate multiple comprehensive lists, contributor credibility scores can be used across the methods. For example, if method 400 is performed three times to generate a comprehensive list for three different list types using the same selected contributors, step 404 can be performed the first time method 400 is performed and then omitted in the subsequent performances of the method, with the contributor credibility scores from the first method being used in the subsequent performances of the method.

The ranked comprehensive list can be displayed to the user on a display device, such as a monitor or screen associated with a client machine. Furthermore, as discussed above, the user can filter the displayed list by product category, keyword, or other filter to show a subset of the list corresponding to the filter value(s). This is different than the user's selection of particular contributors in step 401; the filter causes a subset of the results to be viewed, but the results are still based on all of the selected contributors, whether their products are viewed or not.

### Example

An example is now set forth showing how the invention can be used, according to one embodiment. In this example, the user has selected three contributors, Dave, Jane, and John, from which to generate a consolidated product group list. The user has made this selection after viewing individual lists of many contributors and deciding that the three selected contributors are experts whose ratings the user most trusts. These three trusted contributors each maintain an individual “Loved List” of favorite, recommended products, as well as an individual “Letdown List” of products to be avoided, with both lists being based on the contributor's actual product experience. That is, the contributor has had good experiences with the products the contributor has listed in the “Loved List” and bad experiences with the products the contributor has listed in the “Letdown List.”

Dave has referred 2 individuals to the site who have become contributors and is friends with 25 site contributors. Dave has been selected by 500 contributors to be the contributor's expert. Dave became a contributor 180 days ago and last logged in to the system 3 days ago. Dave has confirmed his e-mail address and has provided a valid mailing address. Table 1 shows the individual lists for Dave (note that the values are exemplary only). The products were added to Dave's list 180 days ago.

TABLE 1
Individual Lists for Dave

| | |
|---|---|
| Product | Rating |

a. Loved List

| | |
|---|---|
| Lenovo ThinkPad Edge 420s | — |
| BlueAnt T1 Headset | — |
| Nintendo Wii | — |

b. Letdown List

| | |
|---|---|
| Apple MacBook Pro | 5 |

Jane has referred no one to the site but has befriended 6 contributors, and has been selected by 1 contributor to be the contributor's expert. Jane became a contributor 90 days ago and last logged in to the system 30 days ago. Jane has confirmed her e-mail address but has not provided a mailing address. Table 2 shows the individual lists for Jane (note that the values are exemplary only). The products were added to Jane's list 80 days ago.

TABLE 2
Individual Lists for Jane

| | |
|---|---|
| Product | Rating |

a. Loved List

| | |
|---|---|
| Nintendo Wii | 5 |
| Apple MacBook Pro | 5 |
| BlueAnt T1 Bluetooth Headset | 5 |
| Blackberry Pearl 8100 | 4 |
| Roku XD | 4 |
| Sony Bloggie | 3 |
| Panasonic Lunix DMC-ZS | 2 |
| Turtle Beach X31 Headset | 2 |
| Microsoft Xbox 360 S | 2 |

b. Letdown List

| | |
|---|---|
| BlueAnt Q1 Headset | 3 |

John has referred 10 individuals to the site who have become contributors and is friends with 12 site contributors. John has been selected by 10 contributors to be the contributor's expert. John became a contributor 30 days ago and last logged in to the system 2 days ago. John has confirmed his e-mail address and has provided a valid mailing address. Table 3 shows the individual lists for John (note that the values are exemplary only). The products were added to John's list 2 days ago.

TABLE 3
Individual Lists for John

| | |
|---|---|
| Product | Rating |

a. Loved List

| | |
|---|---|
| Lenovo ThinkPad Edge 520 | 5 |
| Boxee Box | 5 |
| BlueAnt T1 Bluetooth Headset | 4 |
| Sony Bloggie | 4 |
| Roku XD | 3 |
| Panasonic Lunix DMC-ZS | 2 |

b. Letdown List

| | |
|---|---|
| Apple MacBook Pro | 1 |

For use in this example, the following weights are assigned for the listed factor: each follower: 10,000; each referral: 2,500; each friend 1,000; days since joining minus days since last login: 500; age: 250; mailing address confirmed: 100; e-mail confirmed: 25.

The ranges of values for the 10,000 contributors are set as follows: number of followers: 0 to 3,000; number of referrals: 0 to 200; number of friends, 0 to 600; confirmation of mailing address and e-mail address: true (1) or false (0); elapsed days since last login: 0 to 400; age of contributor: 15 to 90.

Using the above exemplary data, methods 400, 500, 600, and 700 were performed to generate consolidated lists for both the loved list type and the letdown list type. Although only a portion of the method steps are specifically discussed below, it will be appreciated that other, non-discussed, steps of the methods were also performed.

Using step 404, the credibility score was determined for each contributor using the factors and weights identified above. Using equation 1, above, the raw credibility scores were determined as follows:

$$\begin{matrix}R C {S}_{Dave} = 10000 ( \frac{500}{3000} ) + 2500 ( \frac{2}{200} ) + 1000 ( \frac{25}{600} ) + 500 ( \frac{177}{400} ) + \\ 250 ( \frac{25}{75} ) + 100 ( 1 ) + 50 ( 1 ) \\ = 2208.75\end{matrix}$$

$$\begin{matrix}R C {S}_{Jane} = 10000 ( \frac{1}{3000} ) + 2500 ( \frac{0}{200} ) + 1000 ( \frac{6}{600} ) + 500 ( \frac{60}{400} ) + \\ 250 ( \frac{0}{75} ) + 100 ( 0 ) + 50 ( 1 ) \\ = 143.33\end{matrix}$$

$$\begin{matrix}R C {S}_{John} = 10000 ( \frac{10}{3000} ) + 2500 ( \frac{10}{200} ) + 1000 ( \frac{12}{600} ) + 500 ( \frac{28}{400} ) + \\ 250 ( \frac{40}{75} ) + 100 ( 0 ) + 50 ( 1 ) \\ = 506.67\end{matrix}$$

The raw credibility scores were men converted to final credibility scores using the approach discussed above. That is, the final credibility scores for Dave, Jane, and John were calculated based on the respective placement of the raw credibility scores in each quartile. For example, assuming that the rankings of the raw credibility scores of Dave (2208.75), Jane (143.33), and John (506.67) are respectively 8117, 2001, and 5254 (out of the 10,000 contributors), then the raw credibility scores of Dave, Jane, and John respectively fall in the 1st, 4th, and 2nd quartiles. The credibility scores were normalized on a 10-point scale based on a weighted distribution where the 4th quartile is distributed between 0 and 1; the 3rd quartile is distributed between 1 and 3; the 2nd quartile is distributed between 3 and 6; and the 4th quartile is distributed between 6 and 10. Based on this, Dave's position in the top quartile was assigned a score between 6 and 10; Jane's position in the bottom quartile was assigned a score between 0 and 1; and John's position in the upper middle quartile was assigned a score between 3 and 6. For example, the final credibility scores for Dave, Jane, and John were determined by equation 2, above, as follows:

$${FCS}_{Dave} = 6 + 4 ( \frac{8117 - 7500}{2500} ) = 6.9872$$

$${FCS}_{Jane} = 0 + 1 ( \frac{2001 - 0}{2500} ) = 0.8004$$

$${FCS}_{John} = 3 + 3 ( \frac{5254 - 5000}{2500} ) = 3.348$$

Using method 500, the score for each list item was determined. For example, the first item on Dave's “Loved List” is the “ThinkPad Edge 420s.” Since Dave has not given the item a rating, a neutral rating of 3 was assumed. Using equation 3, above, the relative rating of that list item was determined as follows:

rr_{l,Dave}=3*6.9872=20.9616

The list item score was then determined by taking into account the age of the product. For example, the raw product aging factor RPAF was determined using equation 4, above, assuming that the ThinkPad Edge 420s has been generally available for 764 days:

RPAF_{p,Dave}=764−180=584,

If the maximum and minimum raw product aging factors for the list items are respectively 2145 and 138, then the range of raw product aging factors is the difference between the two, or 2007. Using equation 5, above, the final product aging factor for the list item was determined as follows:

$${FPAF}_{p , Dave} = 1 + ( \frac{584}{2007} ) = 1.2909$$

The score for the list item was determined using the relative rating and the final product aging factor using equation 6, above, as follows:

score_{l,Dave}=20.9616*1.2909=27.06104

As such, the list item score for the Lenovo ThinkPad Edge 420s list item entry on Dave's “Loved List” is 27.06104.

Using the same approach for each list item, the corresponding list item scores were determined, as discussed above with respect to method 500.

Using method 600, an overall score was determined for each product group. To do so, all of the list item scores of all of the list items corresponding to the product group were aggregated. For example, the “Nintendo Wii” is included on the “Loved Lists” of both Dave and Jane; thus the list item scores corresponding to the two list items were added together to obtain the overall product group score. As another example, the “Lenovo ThinkPad Edge 502” is included on John's “Loved List.” Although this corresponds to a different version (502) of the “Lenovo ThinkPad Edge” than that (420S) found in Dave's “Loved List,” both releases were determined to correspond to the same product group (e.g., “Lenovo ThinkPad Edge” product group or shortname) based on the similarities between the products. Thus, the overall score for the “Lenovo ThinkPad Edge” product group was determined by adding the scores corresponding to the two list items.

The overall score determined for each product group is shown in Table 4.

TABLE 4
Overall Product Group Scores

| | |
|---|---|
| Product | Overall Score |

a. Loved List

| | |
|---|---|
| Lenovo ThinkPad Edge | 49.85872526 |
| BlueAnt T1 Bluetooth Headset | 48.67165202 |
| Nintendo Wii | 46.80274559 |
| Boxee Box | 25.1271151 |
| Roku XD | 22.8114583 |
| Sony Bloggie | 17.73170583 |
| Panasonic Lumix | 17.19573333 |
| Blackberry | 6.268556054 |
| Microsoft Xbox 360 S | 2.035838565 |
| Turtle Beach X31 Headset | 2.035037369 |
| Apple Macbook Pro | 8.316412556 |

b. Letdown List

| | |
|---|---|
| BlueAnt T1 Bluetooth Headset | 20.39733199 |
| Apple Macbook Pro | 84.46402594 |

Using method 700, the score for each product group having products listed in a “Loved List” and a “Letdown List” is adjusted. In this example, the “BlueAnt Q1 Bluetooth Headset” is considered to be a different product and product group from the “BlueAnt T1 Bluetooth Headset,” because the models have significant differences that yield a different user experience, according to the data and/or expert judgment.

However, the “Apple Macbook Pro” product group is listed on lists corresponding to both list types so a comparison of the product scores for each list type was performed so that the corresponding overall scores can be adjusted. The “Apple Macbook Pro” is listed on Jane's “Loved List” and Dave and John's “Letdown Lists.” The preference ratios corresponding to each of the list types were determined using equation 7, above:

$${PR}_{LovedListType} = \frac{1}{2} = 0.5 , and$$

$${PR}_{LetDownListType} = \frac{2}{1} = 2$$

Using these preference ratios, the test scores corresponding to each list type were determined using equations 8a and 8b, above.

test_{LovedListType}=0.5*8.316412556=4.158206278

test_{LetdownListType}=84.46401594

Because the test score for the letdown list type is greater than the test score for the loved list type, the letdown list type was determined to be the dominant list type. Therefore, the product was removed from the list corresponding to the non-dominant list type (i.e., the “Loved List”) and the overall product group score in the list corresponding to the dominant list type (i.e., the “Letdown List”) was adjusted using equation 9, above:

NewScore_{LetdownList,p}=84.46401594−4.158206278=80.30575316

The product groups were arranged in the consolidated lists using the final overall scores. Table 5 shows the final rankings of the product groups based on the final overall scores.

TABLE 5
Final Rankings

| | | |
|---|---|---|
| Ranking | Product | Overall Score |

a. Loved List

| | | |
|---|---|---|
| 1 | Lenovo ThinkPad Edge | 49.85872526 |
| 2 | BlueAnt T1 Bluetooth Headset | 48.67165202 |
| 3 | Nintendo Wii | 46.80274559 |
| 4 | Boxee Box | 25.1271151 |
| 5 | Roku XD | 22.8114583 |
| 6 | Sony Bloggie | 17.73170583 |
| 7 | Panasonic Lumix | 17.19573333 |
| 8 | Blackberry | 6.268556054 |
| 9 | Microsoft Xbox 360 S | 2.035838565 |
| 10 | Turtle Beach X31 Headset | 2.035037369 |

b. Letdown List

| | | |
|---|---|---|
| 1 | Apple Macbook Pro | 80.30580966 |
| 2 | BlueAnt T1 Bluetooth Headset | 20.39733199 |

In one embodiment, the methods discussed above are performed as part of a software application. The software application can be performed at one or more client machines 102 and/or server machines 104 that communicate through a network 106, as shown in FIG. 1. In one embodiment, the user can access the software application from a client machine 102 by browsing to a web address where the application is hosted. For example, a server machine 104 can act as a web site which hosts the application. Data and other program elements can be exchanged between client machine 102 and server machine 104 over network 106, as is known in the art. Contributors can input their product rating data using the same or different client machines 102. The software application can alternatively be a stand-alone application or any other type of application known to one of skill in the computer arts.

If desired, the software application can display visual icons that quickly or “at a glance” convey information about the product/product group or contributor group to the user. In one embodiment, multiple messages can be conveyed using a single icon. For example, a single visual icon can convey the type of consolidated list on which the product or product group is found (e.g. a blue thumbs up to indicate that the product is on the “Loved List”), the general ranking position of the product or product group on the consolidated list (e.g. three different sized suns or stars or both to indicate which third of the rankings the product falls within), and the group of contributors whose ratings were used to place the product or product group on the particular consolidated list (e.g. a star to indicate that the product is on the ranked list of experts, and the sun to indicate the product is on the ranked list of the general community of contributors).

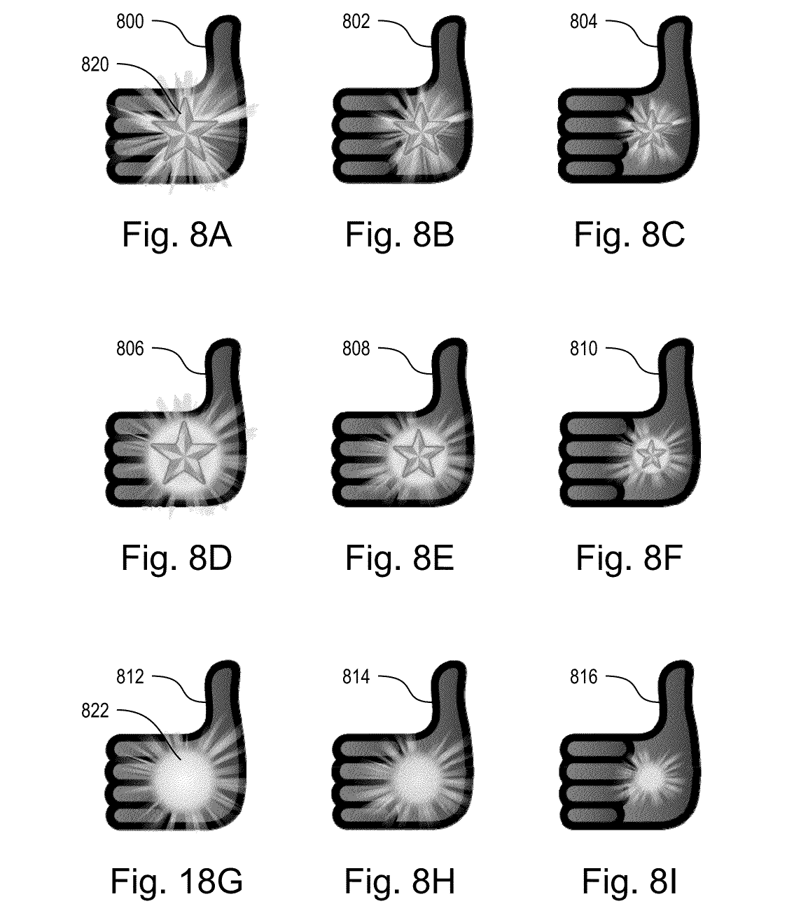

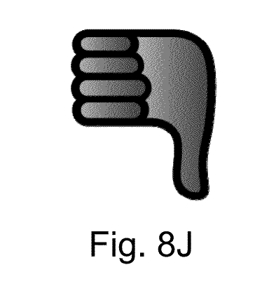

FIGS. 8A-8J depict some examples of various icons 800-816 that can be used to convey multiple messages of a product to a user. Icons 800-816 all include shaded or colored hands with their thumbs directed upward to indicate that the product corresponding to the icon is on a preferred list, such as a “Loved List” or a “Wanted List.” Icon 818 includes a hand with the thumb directed downward to indicate that the product corresponding to the icon is on a non-preferred list, such as a “Letdown List.” Although not shown, the color associated with the hand can further indicate which type of preferred or non-preferred list the product is associated with. For example, a blue hand can represent a “Loved List,” a red had can represent a “Wanted List,” and a yellow hand can represent a “Letdown List.”

Icons 800-816 also include various sizes of stars 820 and/or suns 822 in the icons. Stars 820 and suns 822 represent the groups of contributors whose ratings were used to place the product or product group on the particular consolidated list. For example, stars 820 can correspond to technical experts and suns 822 can correspond to the general community of contributors. As such, a star 820 in the icon can signify that the particular product associated with the icon is on the particular list type generated using individual lists of the technical experts (see, e.g., icons 800-804). Similarly, sun 822 can signify that the particular product is on the particular list type generated using individual lists of the general, inclusive community (see, e.g., icons 812-816). An icon having both a lists star and a sun can signify that the particular product is on the generated ranked lists of both group types (see, e.g., icons 806-810).

Finally, the relative sizes of the stars and suns can indicate the general ranking position of the product or product group on the consolidated list. In one embodiment, three different sizes of stars 820 and suns 822 are used to indicate in which third of the particular list the product is found. For example, large, medium, and small stars or suns, such as those respectively included in icons 806, 808, and 810, can signify that the product is in the top, middle, and bottom third, respectively, of the corresponding list.

Many benefits over present methods of generating ranked lists are obtained using embodiments of the present invention. Some of these include:
rankings of combined lists can be automatically generated;
product experiences of substantially similar products can be combined;
the credibility, authority, relevance and/or trustworthiness of each contributor can be incorporated;
the newness of the products and product groups can be incorporated;
the newness of the ratings of the products by the contributors can be incorporated;
users can quickly and easily, without reading multiple tedious reviews of often suspect credibility, discern which products are most often appreciated and recommended based on real-life product experience; and
multi-dimensional product experiences can be reflected by the various contributors because each contributor can place products on different lists depending on their individual personal experiences.

Although discussion herein has been directed to generating consolidated lists of products, it is appreciated that other types of consolidated lists can also be generated using the methods or variations thereof. For example, consolidated lists of services or web sites can also be generated. In that case, the individual lists of the contributors would contain ratings of the services or web sites as experienced by the contributors. Other types of consolidated lists can also be generated

The present invention may be embodied in other specific forms without departing from its spirit or essential characteristics. Accordingly, the described embodiments are to be considered in all respects only as illustrative and not restrictive.

The scope of the invention is, therefore, indicated by the appended claims rather than by the foregoing description. All changes which come within the meaning and range of equivalency of the claims are to be embraced within their scope.

What is claimed is:

1. A method of automatically generating a consolidated ranked list of products, the method being performed by one or more computer devices, the method comprising:
obtaining a plurality of individual lists corresponding to a plurality of contributors, each individual list providing ratings or rankings of products by a corresponding one of the contributors; and
generating a consolidated list that provides rankings for the products listed on the individual lists, the products being ranked on the consolidated list based on:
the ratings or rankings of the products provided by the contributors, and
a credibility score corresponding to each contributor.

2. The method recited in claim 1, further comprising determining the credibility score corresponding to each contributor.

3. The method recited in claim 2, wherein determining the credibility score corresponding to each contributor comprises:
determining a raw credibility score for the contributor; and
determining a final credibility score for the contributor based on the raw credibility score of the contributor, normalized with respect to the raw credibility scores of the other contributors.

4. The method recited in claim 3, wherein the raw credibility score corresponding to the contributor is based on one or more of the following factors:
a number of users that follow the contributor,
a number of friends associated with the contributor,
a number of persons referred by the contributor that have become contributors,
a length of time the contributor has been a contributor,
a length of time that has elapsed since the contributor has logged in or rated a product,
an age of the contributor, and
a confirmation of personal information of the contributor.

5. The method recited in claim 1, wherein generating the consolidated list comprises:
determining the credibility score corresponding to each contributor;
determining a score for each list item in each individual list based on:
the rating of the product corresponding to the list item, and
the credibility score corresponding to the contributor of the individual list;
determining an overall score for each product based on the list item scores corresponding to the product; and
arranging the products in the comprehensive list in an order reflective of the rankings of the products based on the overall score of each product.

6. The method recited in claim 1, further comprising displaying the comprehensive list on a display device.

7. The method recited in claim 1, further comprising filtering the comprehensive list based on input from a user.

8. A computer readable storage medium having stored thereon computer-executable instructions that, when executed by one or more computer devices, cause the method recited in claim 1 to be performed.

9. A system comprising:
one or more computer devices, comprising:
one or more central processing units; and
physical memory, the physical memory having stored thereon computer-executable instructions that, when executed by the one or more central processing units, cause the method recited in claim 1 to be performed to generate a consolidated list of products; and
a display that displays the consolidated list.

10. A method of generating a ranked list of product groups, the method being performed by one or more computer devices, the method comprising:
obtaining a plurality of individual lists corresponding to a plurality of contributors, each individual list providing ratings or rankings of products by a corresponding one of the contributors;
grouping the products into product groups, at least one of the product groups representing a plurality of different products listed on the individual lists, the different products having substantial similarities to each other; and
generating a consolidated list of the product groups, the product groups being ranked on the consolidated list based on the ratings or rankings of the products corresponding to each product group by the contributors.

11. The method recited in claim 10, wherein generating the consolidated list comprises:
determining a product group score for each product group based on:
the ratings or rankings of the products corresponding to the product group by the contributors, and
a credibility score corresponding to each contributor associated with the products corresponding to the product group; and
ranking the product groups on the consolidated list based on the product group score corresponding to each product group.

12. The method recited in claim 10, wherein generating the consolidated list comprises:
determining a product group score for each product group based on:
the ratings or rankings of the products corresponding to each product group by the contributors, and
a product aging factor of each list item corresponding to each product group; and
ranking the product groups on the consolidated list based on the product group scores.

13. A method of generating a consolidated ranked list of products, the method being performed by one or more computer devices, the method comprising:
obtaining a plurality of individual lists corresponding to a plurality of contributors, each individual list providing ratings of products by a corresponding one of the contributors;
determining a product score for each product based on a product aging factor of each list item;
generating a consolidated list that provides rankings for the products listed on the individual lists, the products being ranked on the consolidated list based on the product score corresponding to each product.

14. The method recited in claim 13, wherein the product aging factor of each list item is based on the newness of the product and the newness of the rating of the product by the contributor corresponding to the list item.

15. The method recited in claim 13, further comprising determining the product aging factor corresponding to each list item of each individual list by:
determining a raw product aging factor for the list item; and
determining a final product aging factor for the list item based on the raw product aging factor of the list item, normalized with respect to the raw product aging factors of the other list items.

16. The method recited in claim 15, wherein the raw product aging factor for the list item is based on:
a first length of time that has elapsed since the product corresponding to the list item has been generally made available to the public, and
a second length of time that has elapsed since the product corresponding to the list item has been rated by the contributor associated with the list item.

17. A method of generating a consolidated ranked list of products, the method being performed by one or more computer devices, the method comprising:
obtaining a first individual list of a first contributor, the first individual list corresponding to a first list type, the first individual list providing ratings of products by the first contributor based on adherence of the products to a nominal characteristic embodied by the first list type.
obtaining a second individual list of a second contributor, the second individual list corresponding to a second list type different than the first list type, the second individual list providing ratings of products by the second contributor based on adherence of the product to a nominal characteristic embodied by the second list type, a particular one of the products listed in the first individual list also being listed in the second individual list.
generating a consolidated list corresponding to the first list type, the consolidated list including the products listed on the first individual list, ranked on the consolidated list based on the ratings of the corresponding products on the first individual list, the ranking of the particular product on the consolidated list being adjusted based on:
the inclusion of the particular product in the second individual list, and
adherence of the particular product to the nominal characteristic embodied by the second list type.

18. The method recited in claim 17, wherein one of the first and second list types corresponds to desired products and the other of the first and second list types corresponds to undesired products, and wherein the ranking of the particular product is adjusted downward in the consolidated list.

19. The method recited in claim 17, further comprising generating a second consolidated list corresponding to the second list type, the particular product being omitted from the second consolidated list.

20. A method of generating a consolidated ranked list of products, the method being performed by one or more computer devices, the method comprising:
determining a subset of contributors based on a selection by a user of one or more selection criteria related to the contributors;
obtaining a plurality of individual lists corresponding to the contributors included in the subset, each individual list providing ratings or rankings of products by a corresponding one of the contributors; and
generating a consolidated list that provides rankings for the products listed on the individual lists, the products being ranked on the consolidated list based on the ratings or rankings of the products provided by each contributor.

21. The method recited in claim 20, wherein the one or more selection criteria includes one or more of the following:
contributors that are recognized experts in a particular industry,
contributors that are user-selected experts,
contributors that are trusted advisors of the user,
contributors that are designated friends of the user,
contributors that belong to a specific demographic group,
credibility level of the contributors, and
contributors that correspond to a specific keyword or category.

22. The method recited in claim 21, wherein the demographic group is based on one or more of the following demographic factors:
age of the contributor,
gender of the contributor,
residence location of the contributor, and
income of the contributor.
